(19) United States
(12) Patent Application Publication
(10) Pub. No.: US 2019/0062138 A1
(43) Pub. Date: Feb. 28, 2019

(54) BEVERAGE DELIVERY VENDING SYSTEM

(71) Applicant: Ramy Elmery, Woodbridge, VA (US)

(72) Inventor: Ramy Elmery, Woodbridge, VA (US)

(21) Appl. No.: 15/690,528

(22) Filed: Aug. 30, 2017

(51) Int. Cl. B67D 1/00; B67D 1/08

(52) U.S. Cl. CPC B67D 1/0035; B67D 1/0888; B67D 2001/075; B67D 1/0858; B67D 1/0078; B67D 1/0047

(57) ABSTRACT

This invention relates to a beverage delivery vending system that provides the consumer with the option of choosing ingredients of their choice, using a computer touchscreen that is connected to a computing system. The ingredients chosen are delivered using a frozen food delivery system. The ingredients are blended using a blending system and dispensed through solenoid valves and into a disposable cup, which is dispended by a cup-dispenser unit. The ingredients are mixed inside the disposable cup using a sanitary mixer. The consumer has the option of payment for the drink in cash, by debit card, and/or credit card.

### CROSS-REFERENCE TO RELATED APPLICATION

The present application is related to and claims priority from prior provisional application Ser. No. 14/816,777, filed Aug. 3, 2015 which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

The present invention relates generally to an integrated method and system for dispensing and blending/mixing beverage flavor/ingredients, thereby producing a beverage, e.g., a smoothie. More particularly, the present disclosure relates to a system and method for creating and delivering healthy customized drinks

### 2. Description of the Related Art

A fast-paced world is faced by everyone today and with this convenience & quality of the beverages consumed have become increasingly important. Beverage consumption is an important part of daily living and one must consume adequate quantities of proper liquids every day in order to maintain health, fitness, and quality of life. Additionally, the ever-expanding number of beverage choices continues unabated as develop and introduce new beverages by the score every year.

With the growth of more beverage choices, custom made drinks have blossomed into big business and the consumer is spoiled for a beverage of their choice with ingredients of their choice. Some of the popular retail beverage locations will provide a beverage consumer with the option of selecting a “base” liquid (e.g., milk, fruit juice, vegetable juice, etc.) and then water or ice may be added to achieve the desired consistency and volume for the beverage. Many locations will provide the consumer with the option to add in fruit or vegetables and other types of ingredients. Some of them include vitamins, minerals, fiber, and herbs that are believed to provide the beverage consumer with the desired balance of ingredients for a delicious and healthy beverage. Eventually, all of these ingredients are placed into a mixer or blender, blended together, and then delivered to the beverage consumer for consumption.

U.S. Pat. No. 8,534,501, discloses an assembly for dispensing and mixing a beverage that includes an ice dispenser assembly, a flavor/ingredient dispensing module, and a blender/mixer/cleaning module as one integrated assembly and a controller that provides integrated control between menu selection, portioning of ice and dispensing of the ingredient(s) based upon the menu selection performed by the customer, and blending and/or mixing based upon the menu selection. The controller also activates the cleaning mode.

U.S. Pat. App. No. 2012020285986, discloses a system for the automated preparation and delivery of customized beverages. The system is deployed as a kiosk or similar device and provides an automated user-customizable drink purchasing experience. The user can select the desired base, add-in ingredients, etc. and receive a drink that has been prepared in accordance with the user preferences.

U.S. Pat. No. 8,685,477, discloses a method and apparatus for preparing a single serving of a frozen slurry beverage in a disposable drink container or cup. The method of the present invention comprises the steps of creating substantially uniform frozen slurry beverage of a predetermined consistency; and removing the disposable drink container or cup with the substantially uniform frozen slurry beverage from the beverage blending station of the beverage blending device.

Accordingly, without additional improvements in the current systems, products, and methods for creating and delivering customized drinks such as smoothies, the overall process and user experience will continue to be sub-optimal.

Thus, there is a long-felt need to provide a beverage delivery vending system that provides touchscreen for users to customize the ingredients; creates beverage inside drink container or cup; and comes with replaceable cartridges of frozen fruits, proteins, kale etc. for delivering a beverage that satisfies customers on the move, who want a beverage of their selected ingredients and, at the same time that is cost effective. Therefore, in this way this invention provides a smoothie delivery vending system which has all advantages of previous arts but overcomes their disadvantages.

### BRIEF SUMMARY OF THE INVENTION

In the view of the foregoing disadvantages inherent in the known types of protective covering now present in the prior art, the present invention provides an improved protective covering. As such, the general purpose of the present invention, which will be described subsequently in greater detail, is to provide a new and improved sleeve phone case which has all the advantages of the prior art and none of the disadvantages.

An object of the invention is to provide a smoothie delivery vending system for delivering healthy beverage for customers on the move.

It is another object of the present invention to provide a smoothie delivery vending system with touchscreen for delivering healthy smoothie with customized ingredients.

It is another object of the present invention to provide a smoothie delivery vending system with replaceable cartridges of frozen fruits, vegetables, kale etc.

It is another object of the present invention to provide a smoothie delivery vending system with for delivering customized smoothie with a clean dispensing system in place.

It is another object of the present invention to provide a system and method that help create smoothie inside a disposable cup with customized ingredients using a sanitary mixer.

It is another object of the present invention to provide substantially uniform smoothie of a predetermined consistency.

It is another object of the present invention to create a smoothie or other frozen drink in 20 seconds or less.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The figures which accompany the written portion of this specification illustrate embodiments according to the teachings of the present invention.

FIG. 1 shows the front view of the smoothie delivery vending system.

FIG. 2 shows the back view of the rear loading vending machine of smoothie delivery vending system.

FIG. 3 shows the prospective view of storage bins for fruits and vegetables, and credit card processing unit of the smoothie delivery system.

FIG. 4 shows the prospective view of storage bins for fruits and vegetables, blender and non-frozen beverage mixer.

FIG. 5 shows the revolving drum mechanism vending system.

FIG. 6 shows the revolving drum mechanism vending system.

FIG. 7 shows the smoothie delivery vending system.

FIG. 8 shows an alternate embodiment of the smoothie delivery vending system including a plurality of cartridges connected together on successive adjacent edges via interdigitating connectors.

FIG. 8a shows an interdigitating connector of the alternate embodiment of FIG. 8.

FIG. 9 shows the alternate embodiment of the smoothie delivery vending system including a plurality of cartridges connected together via a circular connector member formed as a band having spaced connectors thereon interdigitating with connectors attached to respective cartridges.

FIG. 9a shows an interdigitating connector of the alternate embodiment of FIG. 9.

FIG. 10 shows a perspective view of the alternate embodiment of the smoothie delivery vending system.

FIG. 11 shows a front view of the alternate embodiment of the smoothie delivery vending system.

FIG. 12 shows a cut-away view of a valve member in an open position and including a solenoid control member of one of the plurality of cartridges of the alternate embodiment of the smoothie delivery vending system.

FIG. 13 shows a cut-away view of a valve member in a closed position and including a solenoid control member of one of the plurality of cartridges of the alternate embodiment of the smoothie delivery vending system.

The various embodiments of the present invention will hereinafter be described in conjunction with the appended drawings.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

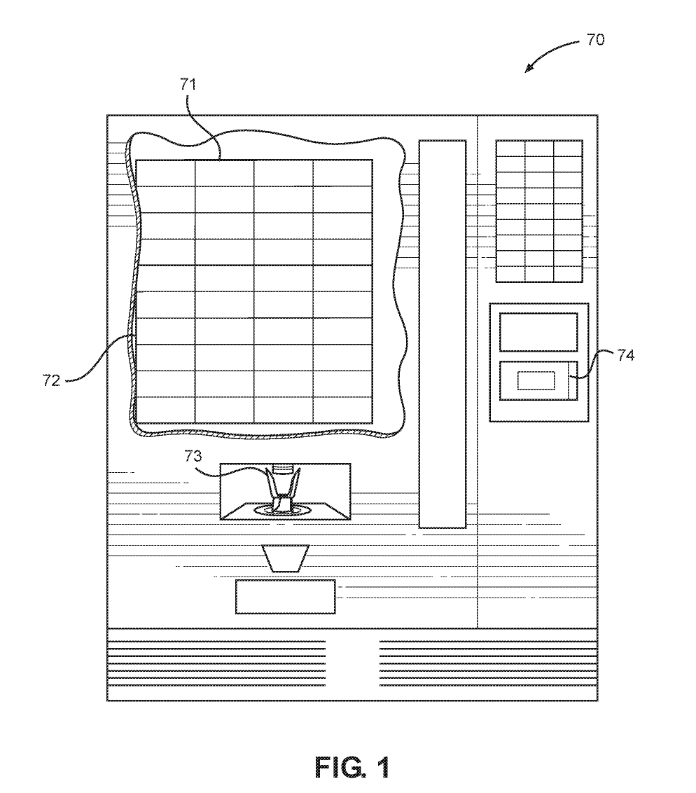

FIG. 1 shows a refrigerator vending machine for delivering ice cubes (70), that consists of different elements such as Freezer elements (71), Refrigerator elements (72), Blades (73) and Rack (74). The freezer elements (71) keep the fruits and vegetables frozen such that they can be used while making different smoothies. The refrigerator elements (72) that forms part of refrigerated food delivery system, that provides cold water and milk. The blender blades (73) are shown in the figure; that blend the various elements which consist of a smoothie. The dispensing system includes an electromechanically operated valve/s known as solenoid valve for dispensing various ingredients into a disposable cup.

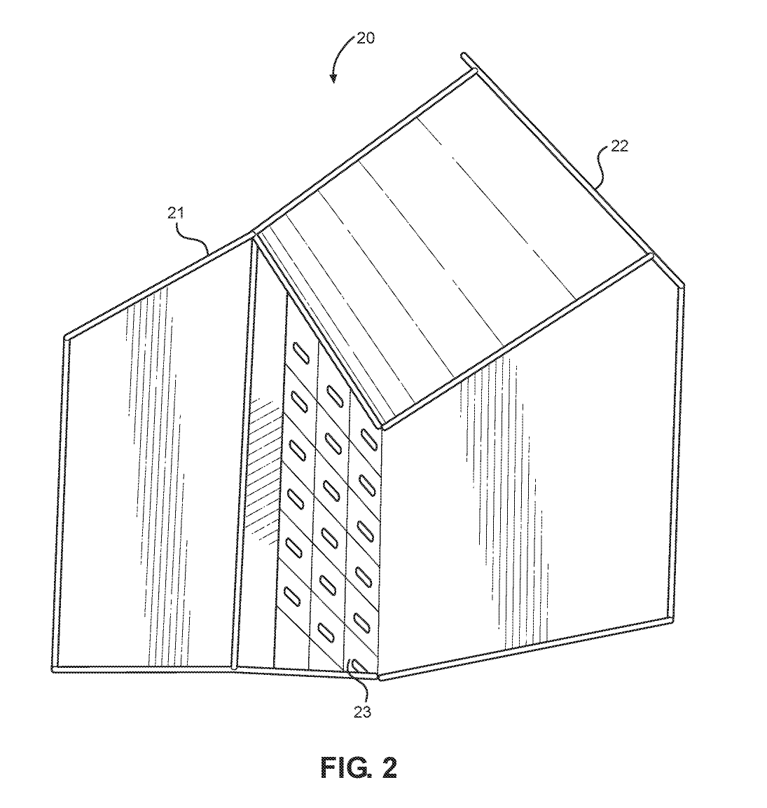

FIG. 2 shows a rear loading vending machine (20) that consists of trays of frozen fruits and vegetables (23) in which the vegetables and fruits that are to be used for making a customized smoothie are kept. These trays form a part of frozen food delivery system. Front (22) and Back door (21) are also shown in the figure.

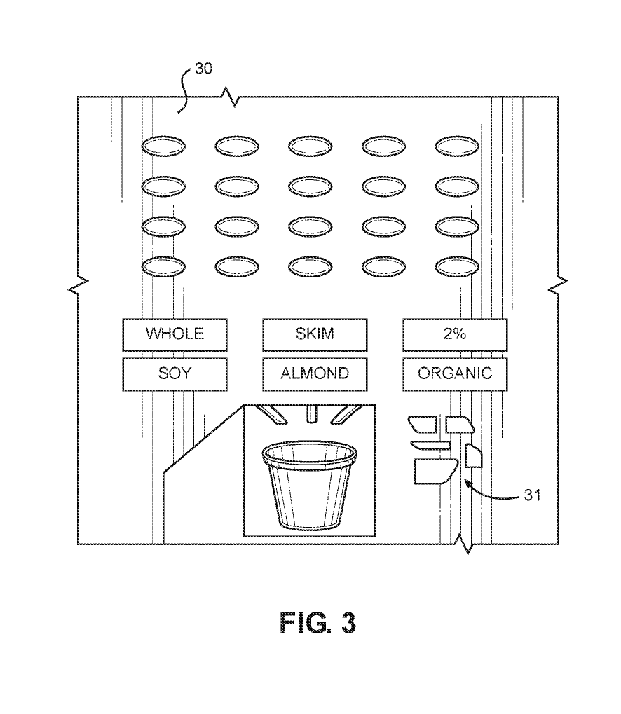

FIG. 3 shows the front view of a smoothie delivery vending machine that gives customized smoothie or my own smoothie (30). The figure also shows slot in the front side of machine a slot for customers to pay for the beverage of their choice by swapping credit card. The credit card processing unit (31) completes the payment process.

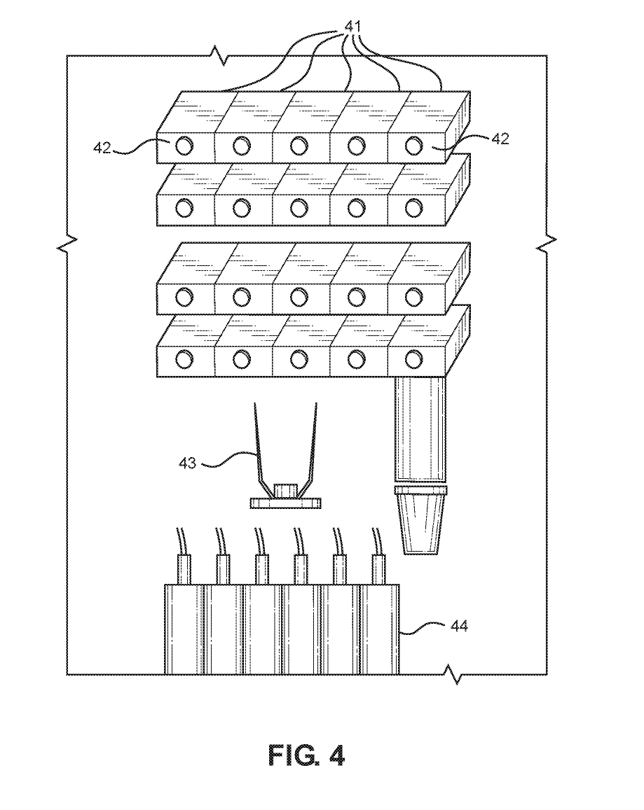

FIG. 4 shows storage cabins (41) for storing frozen fruits and vegetables (42). The machine provides for a blending system that consists of a blender (43) for blending the ingredients for making a beverage (smoothie) of customer's choice. The blending system further provides for water and/or cleaning and/or sanitizing solution supply system connected to a container holder for cleaning and/or sanitizing. Once the order of customer is completed and he/she has their drink, the blender pot is flushed with water and/or sanitizing solution to prevent transfer of flavors or germs. The figure also shows non frozen beverage mixer (44). The mixer used here is a clamp mount ½ HP gear drive electric stainless steel sanitary mixer which are excellent for pharmaceutical, food, cosmetic or dairy application where CIP or wash-down capability is required. This economy model includes a white epoxy wash-down finish in addition to the 316 stainless steel shaft and impellers and can be exposed to high pressure cleaning and detergents. An air solenoid connected to water line can be energized to provide a high-pressure blast of water during the mixer cleaning cycle as well as providing an air blast to assist in removing residual water from the blender module.

FIG. 5 shows the smoothie delivery vending machine with front gate open. Inside the enclosure of the machine are fruit flavors and milk cartridges (51). These cartridges revolve to provide a flavor according to choice of the customer. The figure also shows refrigerator components (52), plastic recycling bin (53), receiving dispenser for blending process (54), smoothie receiving tray (55) and mixing ingredients (56).

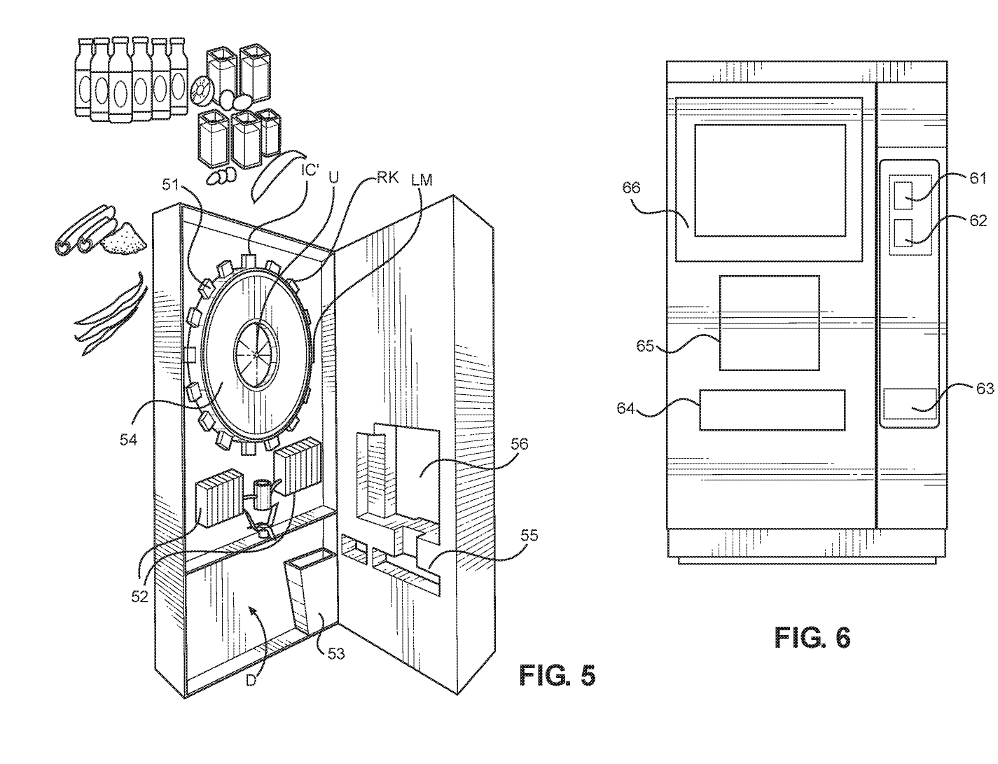

FIG. 6 shows the front view of closed smoothie delivery vending machine. The front portion of the machine has a Barcode reader (61) and Debit card payment slot (62) top right hand corner beside order (selection) screen (66) that provides for touchable surface for placing orders. The figure further refers to plastic recycle bin (63), smoothie receiving tray (64) and mixing ingredients (65).

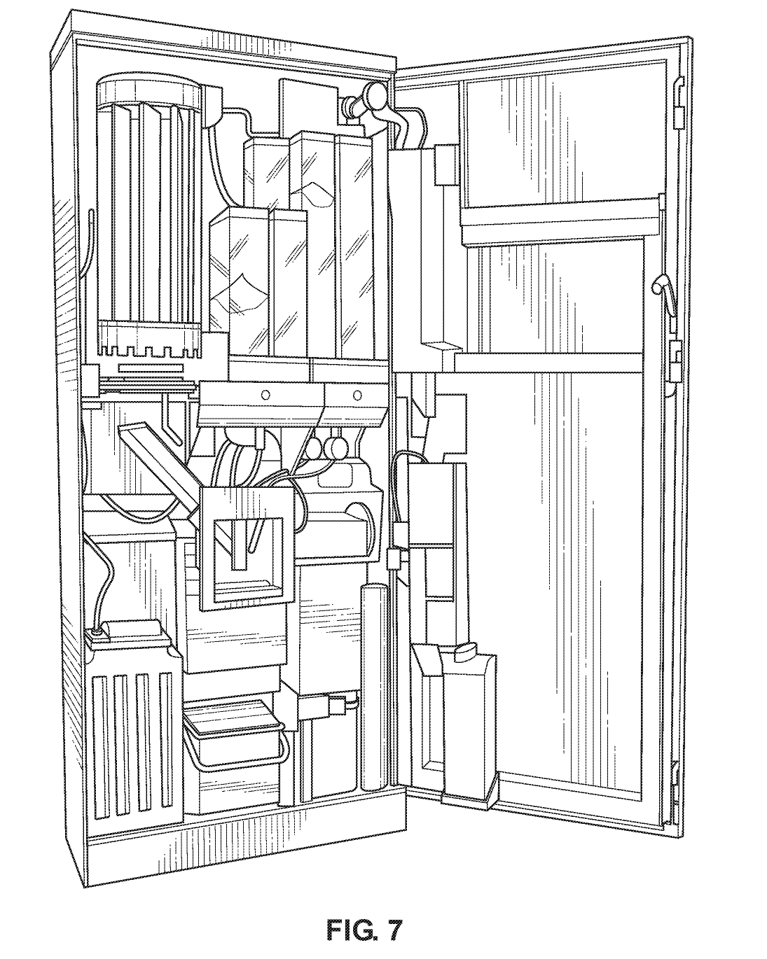

FIG. 7 refers to the front door open view of the proposed smoothie delivery vending machine. The figure shows a cup dispenser-unit (1) that dispenses disposable cups, a water reservoir tank (2) that stores and also provides water for making beverages, Ingredient containers (3) & (4) for storing as well as providing ingredients, a water filter (5) that provides clean water, a beverage selector mechanism (6) for providing customer with beverage option that has been selected. The figure further shows Total-vends counter (7), drinks preset counter (8), display light starters (9), cold-drinks counter (10), display-sign light chokes (11), display-sign lights hinged mounting (12), clear-view vend door (13). The figure also shows a coin-selector mechanism (14) for dispensing change to customer in case of cash payment, a coin box (15) for collecting coins, a cooler unit water-filler plug (16), a cooler unit (17), a hot-water tank thermostat (18), grill (19), a waste bucket (20) and waste-bucket overflow cut-off switch (21).

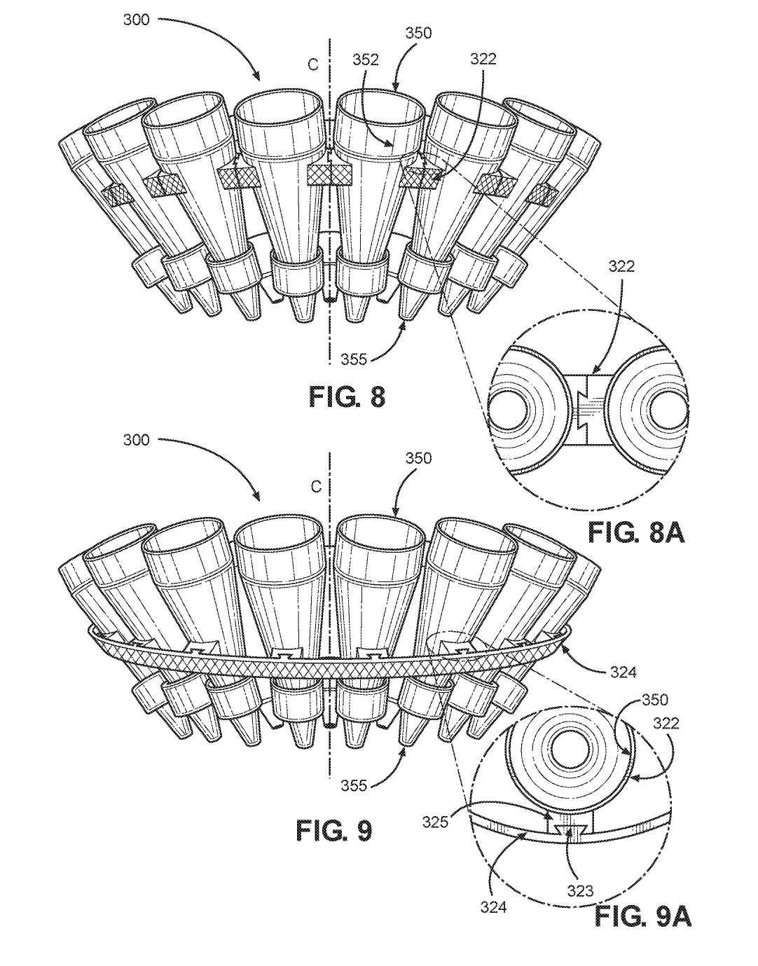

FIGS. 8-13 illustrate an alternate embodiment of the instant invention formed as a beverage delivery vending system 100 comprising a main cabinet 200 including a front panel 205 and an interior volume; a refrigerator compartment 210 located within the interior volume of the main cabinet and is adapted to store and refrigerate a blending device 300 for liquids and food; a blending device 300 including a plurality of cartridges 350 each including at least one wall member 352 forming an interior volume adapted to hold and store liquid or food therein, an aperture 355 on a bottom section thereof adapted to allow the liquid or food to pass therethrough and out of the interior volume, and a valve member 360 mechanically connected to the wall member and is adapted to selectively cover the aperture and allow a predetermined amount of the liquid or food to exit its respective cartridge through the aperture and enter a beverage container member, wherein each of said plurality of cartridges is adapted to be refilled when empty and replaced when empty, and wherein the blending device is located within the refrigerator compartment and is adapted to deliver chosen liquids and food to the beverage container member; and a control panel 210 including computer circuitry 215 adapted to control the valve members of each of the plurality of cartridges, a main screen 218 adapted to provide a user with a variety of beverage selections each adapted to mix predetermined amounts of the liquids and food from predetermined ones of the plurality of cartridges and into the beverage container member, wherein the control panel is located upon the front panel of the main cabinet and is electrically connected to each valve member of each respective cartridge, such that a user can choose a beverage via the control panel, the computer circuitry opens and closes the valve members the respective cartridges, and the liquids and food can enter and become mixed within the beverage container member.

As illustrated in FIGS. 8 and 8a, the plurality of cartridges 350 can be connected together on successive adjacent edges via interdigitating connectors 322 thereof forming a circular configuration having a center point defined by axis “C” thereof, and wherein each of the plurality of cartridges 350 are angled toward the center point such that when the liquids or food exit their respective cartridges they swirl and mix with each other while entering the beverage container member.

As illustrated in FIGS. 9 and 9a, the plurality of cartridges 350 can be connected via a circular connector member 324 formed as a band having spaced connectors 323 thereon interdigitating with connectors 325 attached to each respective cartridge, such that the plurality of cartridges 350 are spaced from one another and releasably connected to the circular connector member 324, and wherein the circular connector member 324 forms a center point defined by axis “C” thereof, and wherein each of the plurality of cartridges 350 are angled toward said center point such that when the liquids or food exit their respective cartridges they swirl and mix with each other while entering said beverage container member.

As illustrated in FIGS. 8 and 9, each of the plurality of cartridges 350 are formed having a cone shape, wherein a top section has a diameter larger than a diameter of the bottom section.

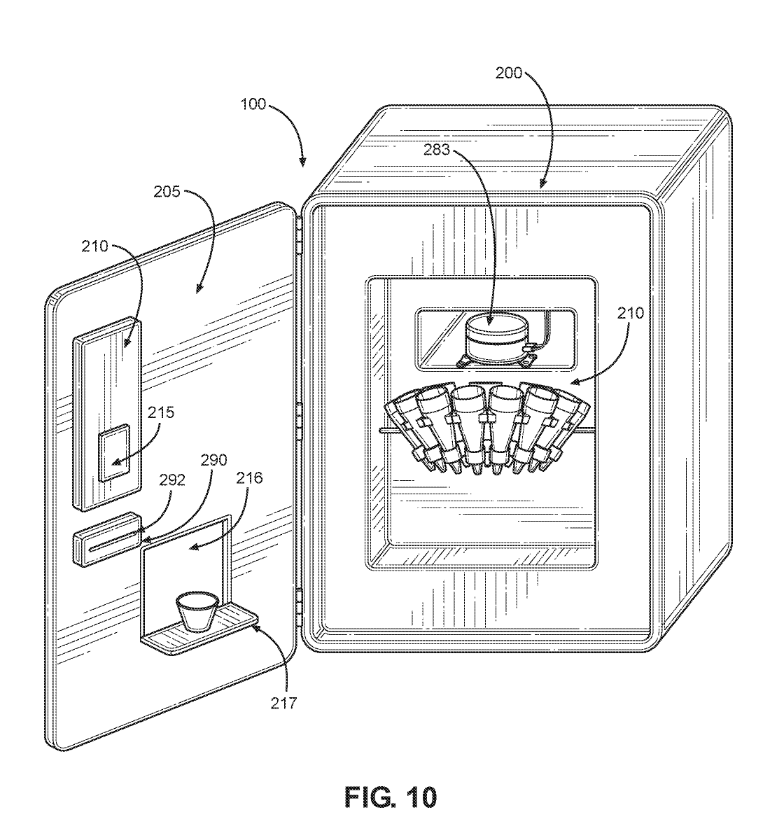

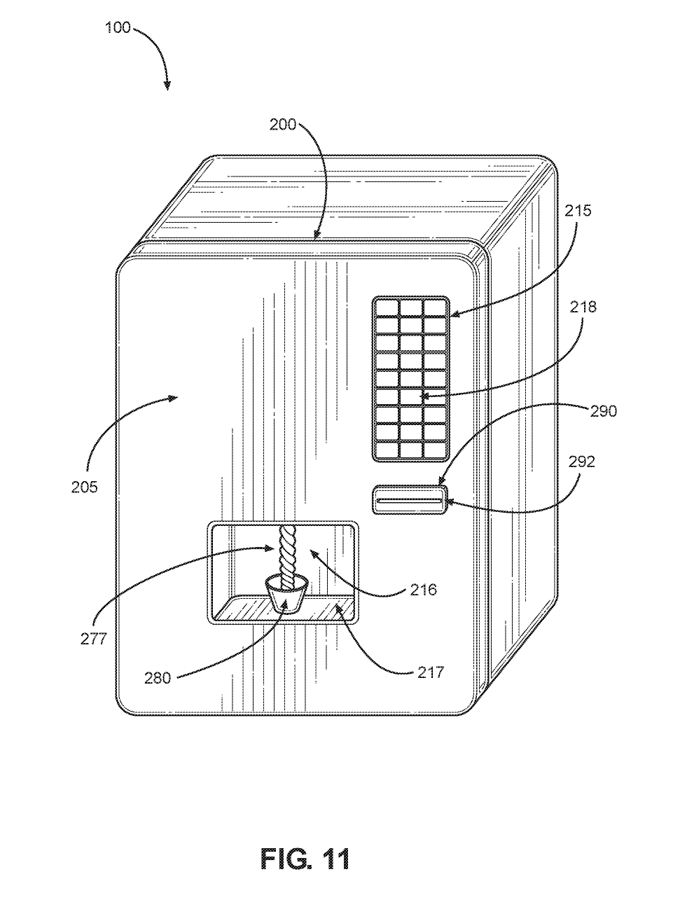

As illustrated in FIGS. 10 and 11, the front panel 205 of the main cabinet further includes a serving opening 216 therethrough, a serving platform 217 connected to the front panel adjacent the serving opening and adapted to extend horizontally therefrom and support beverage container members thereon, and wherein when the liquids or food 277 exit their respective cartridges they swirl and mix with each other and fall towards the serving platform.

The beverage delivery vending system may further include a plurality of beverage container members 280 adapted to be individually placed one at a time upon the serving platform and are adapted to be filled with the liquids or food. The plurality of beverage container members 280 may be formed from plastic or paper.

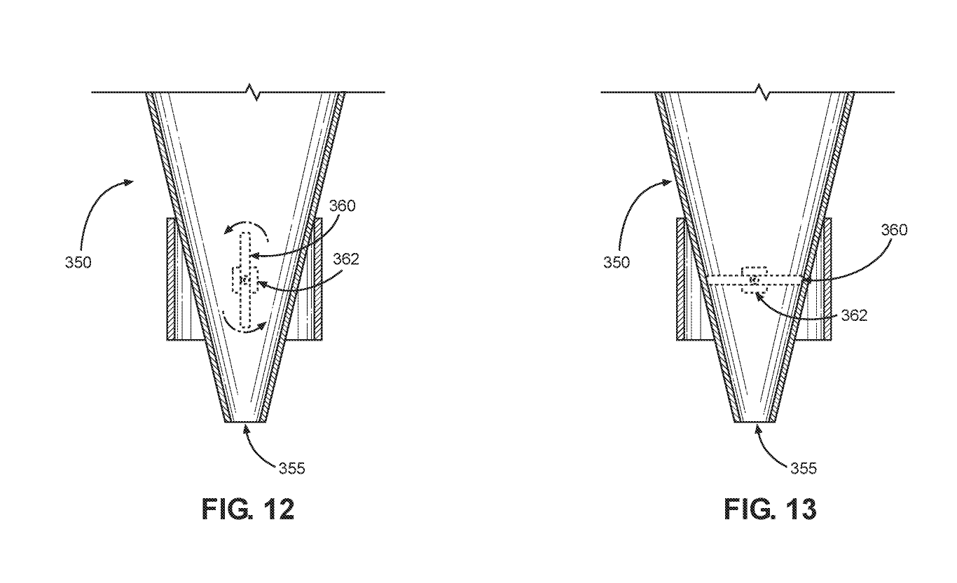

As illustrated in FIGS. 12 and 13, each valve member 360 includes a solenoid control member 362 electrically connected to the control panel and is controlled by the computer circuitry, wherein each of the solenoid control members is adapted to move its valve member to controllably open and close each respective aperture of each respective cartridge to thereby controllably release predetermined amounts of the liquid or food from each respective cartridge.

As illustrated in FIG. 10, the refrigerator compartment 210 includes a compressor member 283 adapted to reduce the temperature within the refrigerator compartment.

The computer circuitry 215 of the control panel 210 includes software encoded thereon that is adapted to allow a user to choose between a plurality of predetermined liquid and food mixtures 277 from the plurality of cartridges.

The front panel 205 of the main cabinet 200 further includes a slot 292 therein housing a credit card processing unit 290 therein adapted to allow customers to pay for a mixture of the liquids and food of their choice by using a credit card. The front panel 205 of the main cabinet 200 may further include a barcode reader, and the computer circuitry 215 include software encoded thereon that is adapted to allow a user to pay using bar codes. The barcode reader could also be configured to read a bar code or the like from the screen of a smart phone. Payments could also be made electronically and remotely as a “pre-order” through a computer device or smart phone and an electronic receiver connected to the computer circuitry 215.

Finally, liquid or a food can be located within each respective cartridge and can include water, ice, juice, fruit, vegetables, coffee, tea, spice, nuts, alcohol, and any other liquid or food ordered with each replaceable cartridge.

Advantageously, the present invention is different from the existing knowledge. Like, prior beverage vending machines provide for only those flavors whose fruits are available in local market. But with this smoothie delivery vending machine, the customer can have a beverage that includes ingredients such a frozen fruits and vegetables of their choice that can be selected using a touchscreen surface. It also provides beverage whose ingredients are blended and mixed inside a disposable cup and delivered in 20 seconds of placing order, thereby avoiding mixing of different flavors and germs. Thus, this machine gives the customer on the move a perfect opportunity to have a smoothie made from ingredients of their choice and at much faster rate as compared to machines in past.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A beverage delivery vending system comprising:
a main cabinet including:
a front panel;
an interior volume;
a refrigerator compartment;
wherein said refrigerator compartment is located within said interior volume of said main cabinet and is adapted to store and refrigerate a blending device for liquids and food;
a blending device including:
a plurality of cartridges each including:
at least one wall member forming an interior volume adapted to hold and store a liquid or food therein;
an aperture on a bottom section thereof adapted to allow said liquid or food to pass therethrough and out of said interior volume; and
a valve member mechanically connected to at least one of said at least one wall member and is adapted to selectively cover said aperture and allow a predetermined amount of said liquid or food to exit its respective cartridge through said aperture and enter a beverage container member;
wherein each of said plurality of cartridges is adapted to be refilled when empty;
wherein each of said plurality of cartridges is adapted to be replaced when empty; and
wherein said blending device is located within said refrigerator compartment and is adapted to deliver chosen liquids and food to said beverage container member; and
a control panel including:
computer circuitry adapted to control said valve members of each of said plurality of cartridges; and
a main screen adapted to provide a user with a variety of beverage selections each adapted to mix predetermined amounts of said liquids and food from predetermined ones of said plurality of cartridges and into said beverage container member;
wherein said control panel is located upon said front panel of said main cabinet and is electrically connected to each said valve member of each respective said plurality of cartridges;
such that a user can choose a beverage via said control panel, said computer circuitry opens and closes said valve members of respective said cartridges, and said liquids and food can enter and become mixed within said beverage container member; and
wherein said plurality of cartridges are connected together on successive adjacent edges thereof forming a circular configuration having a center point thereof and a center vertical axis therethrough; and wherein each of said plurality of cartridges have vertical walls that are configured to be angled toward said center point and with respect to said center vertical axis such that when said liquids or food exit their respective said cartridges they swirl and mix with each other while entering a beverage container member.

14. (canceled)

15. The beverage delivery vending system of claim 13, wherein said blending device further includes a circular connector member.

16. The beverage delivery vending system of claim 13, wherein each of said plurality of cartridges are formed having a cone shape, wherein a top section has a diameter larger than a diameter of said bottom section.

17. The beverage delivery vending system of claim 13, wherein said front panel of said main cabinet further includes:
a serving opening therethrough;
a serving platform connected to said front panel adjacent said serving opening and adapted to extend horizontally therefrom and support beverage container members thereon;
wherein when said liquids or food exit their respective said cartridges they swirl and mix with each other and fall towards said serving platform.

18. The beverage delivery vending system of claim 17, further comprising a plurality of beverage container members adapted to be individually placed one at a time upon said serving platform and adapted to be filled with said liquids or food.

19. The beverage delivery vending system of claim 13, wherein each said valve member includes a solenoid control member electrically connected to said control panel and controlled by said computer circuitry; and wherein each said solenoid control member is adapted to move said valve member to controllably open and close each respective said aperture of each respective said cartridge, to thereby controllably release predetermined amounts of said liquid or food from each respective said cartridge.

20. The beverage delivery vending system of claim 13, wherein said refrigerator compartment includes a compressor member adapted to reduce the temperature within said refrigerator compartment.

21. The beverage delivery vending system of claim 13, wherein said computer circuitry of said control panel includes software encoded thereon and adapted to allow a user to choose between a plurality of predetermined liquid and food mixtures from said plurality of cartridges.

22. The beverage delivery vending system of claim 17, wherein said front panel of said main cabinet further includes a slot therein housing a credit card processing unit therein adapted to allow customers to pay for a mixture of said liquids and food of their choice by using a credit card.

23. The beverage delivery vending system of claim 18, wherein said plurality of beverage container members are formed from a material chosen from a group of materials consisting of plastic and paper.

24. The beverage delivery vending system of claim 13, wherein a liquid or a food is located within each respective said plurality of cartridges; and wherein said liquid or a food is chosen from a group of liquids and food consisting of water, ice, juice, fruit, vegetables, coffee, tea, spice, nuts, and alcohol.
